(19) United States
(12) Patent Application Publication
(10) Pub. No.: US 2005/0279550 A1
(43) Pub. Date: Dec. 22, 2005

(54) Hinge arrangement

(76) Inventors: David Saville, Chelmsford (GB); David Mason, Bromley (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/057,571

(22) Filed: Feb. 14, 2005

(30) Foreign Application Priority Data
Feb. 14, 2004 (GB) 0403323.9

(51) Int. Cl. B62D 25/10

(52) U.S. Cl. 180/69.21

(57) ABSTRACT

A hinge mechanism 14, 114 for pivotally mounting a motor vehicle bonnet 12 to a body structure 13 of a motor vehicle 10 is disclosed. The rear end of the bonnet 12 is pivotally attached to a vehicle body 13 by a pair of hinge mechanisms 14 such that, when the hinge mechanisms 14 are in the normal operating position, the hinge mechanisms 14 allow the bonnet 12 to pivot about a first axis. However, when a greater than normal upward force is applied to the rear end of the bonnet 12, the hinge mechanisms 14 allow the bonnet 12 to rise up to a pre-determined height whilst limiting the rearward displacement of the bonnet 12 so that the bonnet 12 is unable to come into contact with a windscreen 6 of the motor vehicle 10. The hinge mechanisms 14 are able to be subsequently reset to the normal operating position when a downward force is applied to the bonnet 12.

### FIELD OF THE INVENTION

This invention relates to a hinge arrangement intended particularly, but not exclusively, for pivotally mounting a motor vehicle bonnet on the body of a motor vehicle.

In some countries a motor vehicle bonnet is known as a hood, but hereinafter, the term bonnet will be used.

### BACKGROUND OF THE INVENTION

There are increasing demands for motor vehicle design to take account of pedestrian safety and, so far as possible, to design vehicles so that in an impact between a pedestrian and a vehicle, the pedestrian has a reasonable chance of avoiding serious injury or death.

In the case of a frontal impact between a moving vehicle and a pedestrian, the pedestrian is usually thrown onto the vehicle bonnet. If there is sufficient empty space beneath the bonnet, the deformable nature of the sheet metal of the bonnet will afford some protection because the energy of the impact can be absorbed to some extent by deformation of the bonnet. However modern vehicle design is such that there is often very little free space in the engine compartment and so there is usually a very limited amount of possible deformation of the bonnet before the impact of the pedestrian on the vehicle is transmitted to one or more unyielding engine components.

In order to avoid this problem it is known to provide a mechanism which lifts the rear edge of the bonnet in the event of an impact so that the energy of the pedestrian falling into the vehicle can be absorbed by deformation of the bonnet.

### SUMMARY OF THE INVENTION

It is an object of the invention to provide a mechanism which allows the rear edge of the bonnet to be rapidly lifted in the event of a pedestrian collision but can be reset to a normal working condition.

According to a first aspect of the invention there is provided a hinge mechanism for providing a hinged connection between a bonnet and a body structure of a motor vehicle, the hinge mechanism comprising a first hinge leaf pivotally attached to part of the body structure of the motor vehicle and a second hinge leaf attached to the bonnet and being pivotally connected to the first hinge leaf so that, under normal working conditions, the first and second leaves are able to pivot relative to one another about a single pivot axis and a normally fixed but releasable connection between the first leaf and the body structure of the motor vehicle to prevent relative rotation between the first leaf and the body structure of the motor vehicle wherein the releasable connection is released when sufficient force is applied to the bonnet so as to allow the first leaf to rotate about a second pivot axis relative to the body structure of the motor vehicle.

The releasable connection may comprise a retainer member located in an arcuate slot and a retaining means to hold the retainer member at one end of the slot until sufficient force is applied to the bonnet.

The retainer member and the second leaf may be connected to the body structure by means of a third leaf.

According to one embodiment of the first aspect of the invention the retaining means comprises of at least one protrusion on the surface of the first leaf to hold the retainer member at said one end of the slot.

There may be two protrusions on the surface of the first leaf which hold the retainer member at said one end of the slot.

The or each protrusion may be elastically deformed when sufficient force is applied to the bonnet so as to release the retainer member from said one end of the slot thereby permitting rotation of the first leaf relative to the body structure of the motor vehicle.

According to a second embodiment of the first aspect of the invention the retaining means comprises of at least one detent biased into contact with the retainer member by a spring.

In which case, when sufficient force is applied to the bonnet the retainer member may be able to ride over the or each detent so as to release the retainer member from said one end of the slot.

By applying sufficient force to the bonnet the releasable connection may be reset so as to prevent rotation of the first leaf relative to the body structure of the motor vehicle and restore the hinge mechanism to said normal working condition.

In the case of the first embodiment, the retainer member may elastically deform the or each protrusion during the resetting process so that after traversing the or each protrusion the retainer member is once again captured by the or each protrusion in said one end of the slot.

In the case of the second embodiment, the retainer member may move the or each detent out of the way to allow it to reach said one end of the slot during the resetting process.

Preferably, the retainer member may be one of a bolt and a pin fastened either directly or indirectly to the body structure of the motor vehicle.

The width of the slot may vary along its length so as to produce interference between the slot and the retainer member as the retainer member approaches the opposite end of the slot.

The slot may have an inner circumferentially extending edge and an outer circumferentially extending edge and the radius of at least one of the circumferentially extending edges with respect to the second pivot axis varies along the length of the slot so as to provide interference between the slot and the retainer member as the retainer member approaches the opposite end of the slot.

According to a second aspect of the invention there is provided a motor vehicle having body structure and a bonnet pivotally connected to the body by means of a pair of hinge mechanisms in accordance with said first aspect of the invention.

The pair of hinge mechanisms may be fastened near to a rear edge of the bonnet adjacent a windscreen of the motor vehicle.

The bonnet may be raised by means of an actuator when a collision with a pedestrian is predicted to occur.

A means may be provided to prevent the bonnet from immediately returning to its normal closed position from its raised position after the bonnet has been raised by the actuator.

### BRIEF DESCRIPTION OF THE DRAWINGS

The invention will now be further described, by way of example, with reference to the accompanying drawings, in which:

FIG. 1 is a side view of the front part of a motor vehicle with a pair of hinge mechanisms according to the invention showing one hinge mechanism in a normal working condition;

FIG. 2 is a view similar to FIG. 1 but showing the hinge mechanism in an extended position;

FIG. 3 is an enlarged view of the hinge mechanism shown in FIG. 1;

FIG. 4 is an enlarged view of the hinge mechanism shown in FIG. 2; and

FIG. 5 is a view similar to that shown in FIG. 3 but showing an alternative embodiment of the invention.

### DETAILED DESCRIPTION OF THE PREFERRED EMBODIMENT

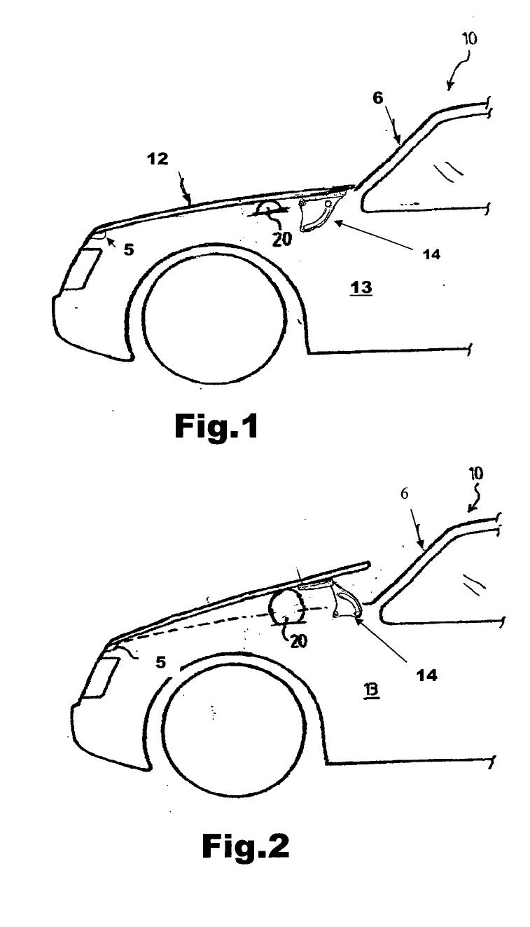

With reference to FIGS. 1 to 4 there is shown a motor vehicle 10 having a bonnet 12 which is shown in the closed or normal operating condition in FIG. 1. The front end of the bonnet 12 is retained by a catch 5 mounted on the vehicle body 13 and the rear end of the bonnet 12 is pivotally attached to the vehicle body 13 at each side by a hinge mechanism 14, of which only one is shown, near to a windscreen 6 of the motor vehicle 10.

When the catch 5 is released, the front end of the bonnet 12 can be raised so that the bonnet 12 opens in the normal way by pivoting about a first axis provided by the hinge mechanisms 14.

However, if a collision sensor (not shown) senses a collision of the type that might involve a pedestrian, a control system (not shown) connected to the sensor is operable to determine whether a pedestrian collision is predicted to occur and, if such a collision is predicted to occur, an actuator in the form of an air bag 20 located beneath the rear end of the bonnet 12 is deployed. It will be appreciated that various other mechanism could be used as a replacement for the airbag such as pyrotechnic rams, spring mechanisms and pneumatic rams. In addition, the actuator can be deployed when actual contact occurs or, preferably, prior to actual contact occurring.

The deployment of the airbag 20 produces an upward force on the bonnet 12. The upward force causes the rear end of the bonnet 12 to rise whilst the front end pivots on the latch mechanism 5 so that the bonnet 12 adopts an emergency position that is raised and inclined with respect to the closed position. This raised position is shown in FIG. 2. This raised bonnet position helps to reduce the risk of serious injury to a pedestrian falling upon the bonnet 12 since the bonnet 12 can now deform to a greater depth before coming into contact with the engine components located beneath. In addition, the inclination of the bonnet 12 will help to keep a pedestrian away from the windscreen wipers (not shown) of the motor vehicle 10.

To prevent the bonnet 12 from immediately returning to its normal position a means or device is provided to restrict the downward motion of the bonnet 12. This may be in the form of the airbag itself which can be allowed to deflate slowly, it may be some other device, or can be formed as part of the hinge mechanism itself. In each case the means or device used should provide a restriction to downward motion of the bonnet so that the bonnet is able to move downwardly against the resistance of the device or means thereby absorbing some of the impact of the pedestrian against the bonnet.

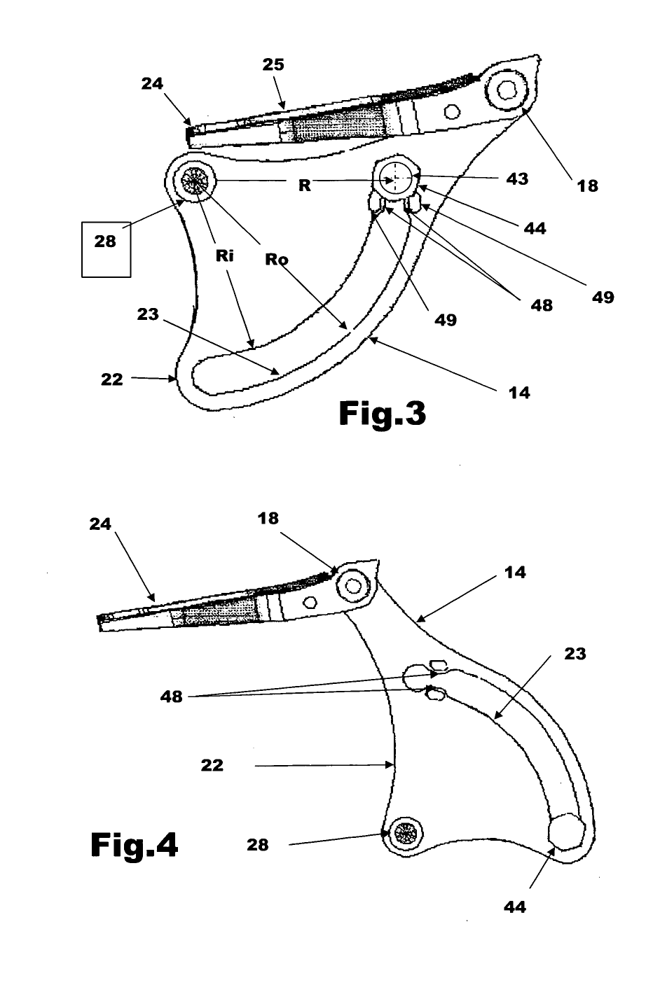

In order to allow the rear end the bonnet to be lifted as shown in FIG. 2, one hinge mechanism 14 is shown in more detail in FIGS. 3 and 4.

The hinge mechanism 14 comprises of two steel leaves, a first or lower leaf 22 pivotally attached to part of the body structure 13 by means of a pivot pin 28 and a second or upper leaf 24 fixedly attached to the bonnet 12.

The lower and upper leaves 22, 24 are rotatable about the first pivot axis formed by a hinge pin 18 and the lower leaf 22 is rotatable about a second pivot axis formed by the pivot pin 28. The first and second pivot axes are situated at opposite ends of the lower leaf 22.

The upper leaf 24 has a flange 25 for connection to a structural part of the bonnet 12.

The lower leaf 22 is in the form of a steel plate in which an arcuate slot 23 is formed. The slot 23 has an inner circumferentially extending edge of radius Ri with respect to the second pivot axis and an outer circumferentially extending edge of radius Ro with respect to the second pivot axis.

A retainer member in the form of a bolt 44 is retained at one end of the slot 23, in this case the upper end, by a retaining means in the form of two protrusions 48 which project into the slot 23. The bolt 44 is threadingly engaged with a threaded member (not shown) fastened to the body structure 13 of the motor vehicle 10. It will be appreciated that the bolt 44 could be replaced by a pin welded or fastened in some other way to the body structure 13.

The bolt 44 has a shank 43 of diameter ‘D’ and has a longitudinal axis that is positioned a distance ‘R’ from the second pivot axis. The width of the slot 23 is of uniform width and is slightly greater than the diameter ‘D’ of the shank 43 so that the shank 43 can move freely along the slot 23 once it has passed by the two protrusions 48.

The radius Ri of the inner circumferentially extending edge is slightly less than R−D/2 and the radius Ro of the outer circumferentially extending edge is slightly greater than R+D/2.

However it will be appreciated that the radius of at least one of the circumferentially extending edges with respect to the second pivot axis could vary along the length of the slot 23 so as to provide interference between the slot 23 and the shank 43 as the shank 43 approaches the opposite end of the slot 23. That is to say the outer radius Ro could gradually reduce until Ro is slightly less than R+D/2 or the inner radius Ri could increase until Ri is slightly greater than R−D/2. As another alternative both of the inner and outer radii could vary. As yet another alternative the width of the slot may vary along its length or towards the other end of the slot to produce a slight interference with the shank 43. It will also be appreciated that interference could be produced by have a different location for the centre of radius of the arcuate slot than the second pivot axis.

In all cases this interference will produce a resistance to motion of the lower leaf 22 as it approaches the opposite end of the slot 23 to the position where it is retained by the retaining means 48. This resistance to motion is useful in that it slows the lower leaf 22 down thereby reducing the impact of the shank 43 with the opposite end of the slot 23. It is advantageous to reduce the magnitude of this impact for several reasons, firstly it reduces the shock loading on the hinge mechanism 14 but secondly, it reduces oscillation or flutter of the bonnet 12 which can have a negative effect on the impact performance of the bonnet 12. For example, if the bonnet 12 is flexing upwards as a body part impinges against it the relative velocity is greater than if the bonnet is stationary or is moving in a downward direction.

During normal operation of the hinge mechanism, the end of the lower leaf 22 remote from the second pivot axis 28 is releasably attached to the body structure 13 by the two protrusions 48. The protrusions 48 are strong enough so that, when subject to the normal forces produced by bonnet opening and closing, the lower leaf 22 is prevented from pivoting with respect to the body structure 13 about the second axis formed by the pivot pin 28 and the upper leaf 24 of the hinge mechanism 14 behaves as an ordinary hinge leaf rotating about the first pivot axis formed by the hinge pin 18.

When the air bag 20 begins to deploy, the upward force exerted by the air bag 20 on the bonnet 12 is sufficient to force the shank 43 of the bolt 44 past the two protrusions 48 thereby releasing the lower leaf 22 and allowing it to rotate about the second axis relative to the body structure 13. The movement of the shank 43 past the protrusions 48 causes the protrusions to be elastically deformed and the provision of an aperture 49 behind each protrusion 48 assists with such elastic deformation.

Once the shank 43 has passed by the protrusions 48 the lower leaf 22 is free to rotate under the application of the upward force applied by the airbag 20 until the shank 43 impinges against the opposite end of the slot 23. This causes the first pivot axis to move upwardly and forwardly thereby lifting the rear edge of the bonnet into the raised position. If required the catch 5 can be simultaneously released to permit the bonnet 12 to move more freely or it can remain latched in either case it acts as a forward pivot for the bonnet 12.

Once the air bag 20 has deflated, then, provided the bonnet has not been deformed, the hinge mechanism 14 can collapse back into the original position that the hinge mechanism 14 assumes during normal use.

That is to say, after the vehicle has been brought safely to a halt, the bonnet can, provided that it is not too seriously damaged, be reset to its normal working state by applying a large downward force to the bonnet 12 this will cause the shank 43 to ride over the protrusions 48 in the opposite direction thereby re-trapping the shank 43 in the upper end of the slot 23. The bonnet 12 is then restored to a normal working condition and the motor vehicle can be used normally. This is particularly useful if the bonnet 12 has been raised in expectation of a collision but no collision has subsequently occurred or if only minor damage has been caused to the bonnet 12.

It will be appreciated that the bonnet 12 cannot lift too far and/or move too far in a rearward lateral direction and into the vehicle windscreen 6 because it is constrained by the lower leaf 22 and in particular by the length of the slot 23 in the lower leaf 22.

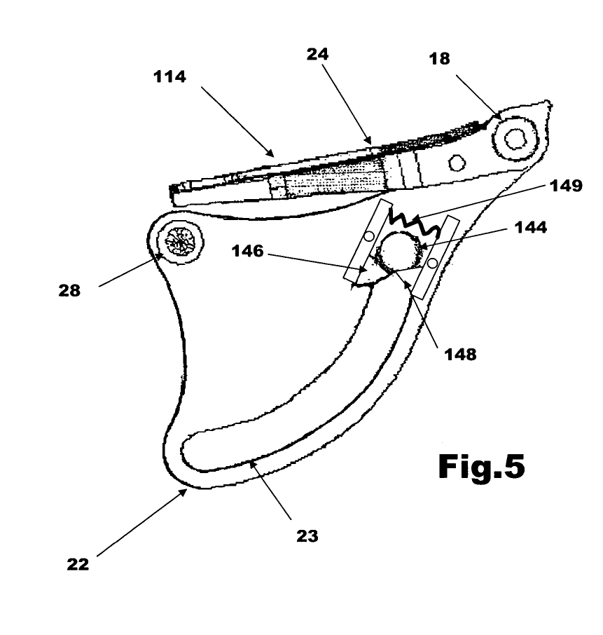

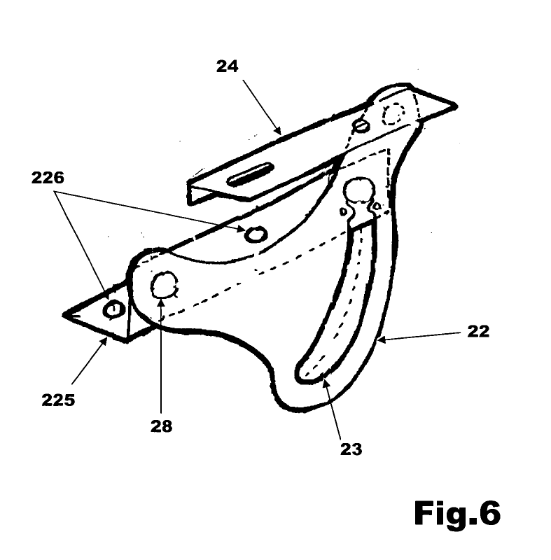

In another embodiment of the hinge mechanism 114 shown in FIG. 5, the hinge mechanism 114 is substantially the same as that previously described with the exception of the structure of the releasable connection and will not be described further except so far as it differs from that previously described.

In this case the retaining means is formed not by two protrusions but by two spring biased detents 146, 148 which are used to hold a pin 144 in the upper end of the slot 23. The detents 146, 148 are pivotally connected to the lower leaf 22 by pivot pins and a compression spring 149 is used to bias the two detents 146, 148 towards each other.

It will be appreciated that other spring and detent arrangements could be used.

As before, the upper leaf 24 is pivotally connected to the lower leaf 22 by a hinge pin 18 and the lower leaf 22 is pivotally connected to part of the body structure 13 of the motor vehicle 10 by the pivot pin 28.

When a force applied to the bonnet 12 by the airbag 20 exceeds a normal level, the pin 144 rides over the detents 146, 148 by pushing the detents 146, 148 out of the way against the action of the spring 149. As before, the mechanism can be reset by applying a large downward force to the bonnet 12 which allows the pin 144 to move the detents 146, 148 out of the way and allow the pin 144 to ride over the detents 146, 148 thereby re-trapping the pin 144 at the upper end of the slot 23.

As in the first embodiment the releasing and resetting of the retaining means produces elastic deformation of the spring 149 thereby retaining its structural integrity.

With reference to FIG. 6 there is shown an alternative embodiment to that shown in FIGS. 3 and 4 but which operates in an identical manner.

In this case instead of the pivot pin 28 and the bolt 44 being connected directly to a vertical surface of the actual body structure of the motor vehicle they are connected by means of a third leaf 225 to horizontal surfaces of the body structure 13. The leaf 225 has a number of apertures 226 formed in it which can be used to fasten it to a horizontal pert of the body structure 13 of the vehicle 10 by means of rivets or threaded fastenings (not shown). Therefore it will be appreciated that the term “pivotally attached to part of the body structure of the motor vehicle” and the term “a normally fixed but releasable connection between the first leaf and the body structure of the motor vehicle” is intended to include both direct connection to the body structure 13, as shown in FIGS. 3 and 4, and via an intermediary leaf, such as shown in FIG. 6.

It will be appreciated that other mechanisms could be used to retain the lower leaf in the normal latched position but that the embodiments shown herein are advantageous in that they are economical to manufacture and efficient in operation.

It will be appreciated that the lower leaf could be formed itself so as to provide a resistance to downward motion of the bonnet by changing the shape or radius of the slot near to the upper end so as to provide interference with the cooperating pin or bolt. However the inclusion of such an additional feature will make the hinge mechanism more difficult to reset as the same resistance to motion will need to be overcome.

It will be appreciated by those skilled in the art that although the invention has been described by way of example with reference to a number of specific embodiments it is not limited to these embodiments and that various alternative embodiments or modifications to the disclosed embodiments could be made without departing from the scope of the invention.

1. A hinge mechanism for providing a hinged connection between a bonnet and a body structure of a motor vehicle, the hinge mechanism comprising a first hinge leaf pivotally attached to part of the body structure of the motor vehicle and a second hinge leaf attached to the bonnet and being pivotally connected to the first hinge leaf so that, under normal working conditions, the first and second leaves are able to pivot relative to one another about a first pivot axis and a normally fixed but releasable connection between the first leaf and the body structure of the motor vehicle to prevent relative rotation between the first leaf and the body structure of the motor vehicle wherein the releasable connection is released when sufficient force is applied to the bonnet so as to allow the first leaf to rotate about a second pivot axis relative to the body structure of the motor vehicle.

2. A hinge mechanism as claimed in claim 1 wherein the releasable connection comprises a retainer member located in an arcuate slot and a retaining means to hold the retainer member at one end of the slot until sufficient force is applied to the bonnet.

3. A hinge mechanism as claimed in claim 2 wherein the retaining means comprises of at least one protrusion on the surface of the first leaf to hold the retainer member at said one end of the slot.

4. A hinge mechanism as claimed in claim 3 wherein there are two protrusions on the surface of the first leaf which hold the retainer member at said one end of the slot.

5. A hinge mechanism as claimed in claim 3 wherein each protrusion is elastically deformed when sufficient force is applied to the bonnet so as to release the retainer member from said one end of the slot thereby permitting rotation of the first leaf relative to the body structure of the motor vehicle.

6. A hinge mechanism as claimed in claim 2 wherein the retaining member comprises at least one detent biased into contact with the retainer member by a spring.

7. A hinge mechanism as claimed in claim 6 wherein when sufficient force is applied to the bonnet the retainer member is able to ride over the or each detent so as to release the retainer member from said one end of the slot.

8. A hinge mechanism as claimed in claim 2 wherein by applying sufficient force to the bonnet the releasable connection can be reset so as to prevent rotation of the first leaf relative to the body structure of the motor vehicle and restore the hinge mechanism to said normal working condition.

9. A hinge mechanism as claimed in claim 8 wherein the retainer member elastically deforms the or each protrusion during the resetting process so that after traversing the or each protrusion the retainer member is once again captured by the or each protrusion in said one end of the slot.

10. A hinge mechanism as claimed in claim 8 when dependent upon claim 6 wherein the retainer member moves the or each detent out of the way to allow it to reach said one end of the slot during the resetting process.

11. A hinge mechanism as claimed in claim 2 wherein the retainer member is one of a bolt and a pin fastened to the body structure of the motor vehicle.

12. A hinge mechanism as claimed in claim 11 wherein the width of the slot may vary along its length so as to produce interference between the slot and the retainer member as the retainer member approaches the opposite end of the slot.

13. A hinge mechanism as claimed in claim 11 wherein the slot has an inner circumferentially extending edge and an outer circumferentially extending edge and the radius of at least one of the circumferentially extending edges with respect to the second pivot axis varies along the length of the slot so as to provide interference between the slot and the retainer means as the retainer means approaches the opposite end of the slot.

14. A motor vehicle having body structure and a bonnet pivotally connected to the body by means of a pair of hinge mechanisms as claimed in claim 1.

15. A motor vehicle as claimed in claim 14 wherein the pair of hinge mechanisms are fastened near to a rear edge of the bonnet adjacent a windscreen of the motor vehicle.

16. A motor vehicle as claimed in claim 14 or in claim 15 wherein the bonnet is raised by means of an actuator when a collision with a pedestrian is predicted to occur.

17. A motor vehicle as claimed in claim 14 wherein a means is provided to prevent the bonnet from immediately returning to its normal closed position from its raised position after the bonnet has been raised by the actuator.

18. A hinge mechanism substantially as described herein with reference to the accompanying drawing.

19. A motor vehicle substantially as described herein with reference to the accompanying drawing.
